(19) United States
(12) Patent Application Publication
(10) Pub. No.: US 2004/0168679 A1
(43) Pub. Date: Sep. 2, 2004

(54) Method of operating a tank ventilation device

(76) Inventors: Karl-Bernhard Lederle, Renningen (DE); Michael Pfeil, Schwieberdingen (DE); Sujay Sirur, Bangalore (IN)

Correspondence Address: STRIKER, STRIKER & STENBY, 103 East Neck Road, Huntington, NY, 11743, US

(21) Appl. No.: 10/776,135

(22) Filed: Feb. 11, 2004

(30) Foreign Application Priority Data
Feb. 28, 2003 (DE) 103 08 784 2

(51) Int. Cl. F02M 25/08

(52) U.S. Cl. 123/520

(57) ABSTRACT

A method of operating a tank ventilation device including a fuel tank of an internal combustion engine and a storage which receives a fuel dispersed from the fuel tank has the steps of connecting the storage through a ventilation conduit with the fuel tank, through a suction conduit with the internal combustion engine, and through an aeration conduit provided with a flow element with an atmosphere, supplying through the storage in a rinsing phase a fresh air which is aspirated via the aerating device, takes fuel and supplies a rinsing fuel flow through the suction conduit to the internal combustion engine, and regulating a fuel concentration in the rinsing volume flow by the flow element provided in the aeration conduit.

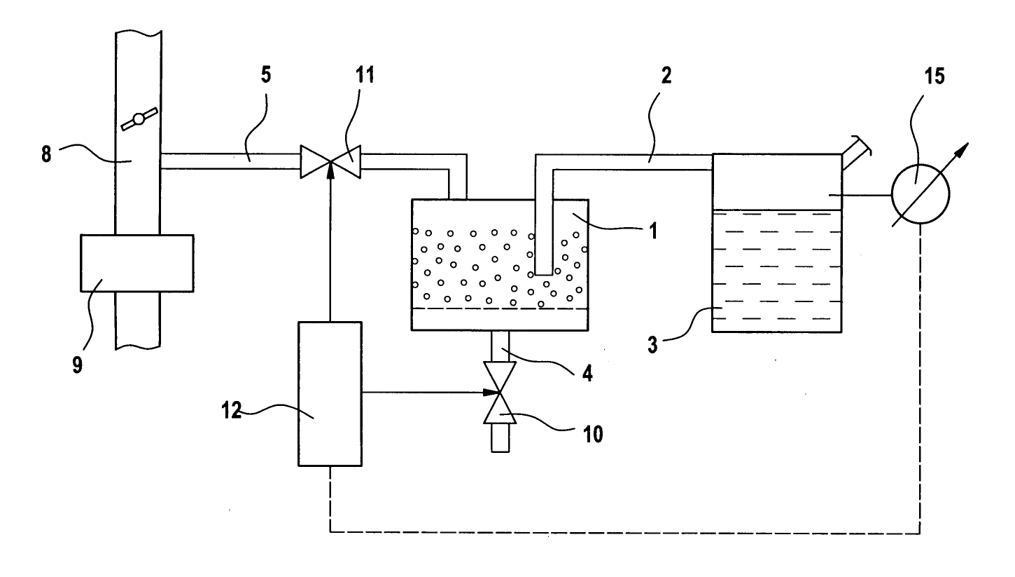

### BACKGROUND OF THE INVENTION

The present invention relates to a method of operating a tank ventilation device.

Patent document DE 198 30 234 C2 discloses a method for tank leak diagnosis in which fresh air aspirated from the atmosphere passes via an aeration conduit through a storage which absorbs a fuel vapor in a tank ventilation device. The fuel received by the storage is released to the air. Thereby the air is delivered to the fuel received by the storage. The fuel-air mixture which is formed in this way is supplied as a so-called rinsing volume through a tank ventilation valve into a suction pipe of an internal combustion engine. In the aeration conduit a regulating check valve is provided and controlled so that a predetermined negative pressure is produced in the tank ventilation device. The signal of a pressure sensor arranged in a fuel tank is used as a regulating variable. It is however disadvantageous that the negative pressure in the fuel tank is maintained constant, since thereby the fuel concentration in the rinsing volume flow significantly fluctuates, depending on the fuel filling of the storage. This can lead in certain operational conditions, for example in idle running, to unquite running of the internal combustion engine.

A negative pressure in the suction pipe is used for suction of the rinsing volume stream. The negative pressure in the suction pipe is however dependent very differently on the motor performance. In throttled motors for example only a low negative pressure in the aspiration pipe is available, so that a rinsing time in which the storage substantially completely discharges the fuel is very long. A throttling of the motor for increase of the negative pressure in the suction pipe increases the fuel consumption of the internal combustion engine.

### SUMMARY OF THE INVENTION

Accordingly, it is an object of the present invention to provide method of operating a tank ventilation device, which avoids the disadvantages of the prior art.

In keeping with these objects and with others which will become apparent hereinafter, one feature of the present invention resides, briefly stated, in a method of operating a tank ventilation device including a fuel tank of an internal combustion engine and a storage which receives a fuel dispersed from the fuel tank, comprising the steps of connecting the storage through a ventilation conduit with the fuel tank, through a suction conduit with the internal combustion engine, and through an aeration conduit provided with a flow element with an atmosphere; supplying through the storage in a rinsing phase a fresh air which is aspirated via the aerating device, takes fuel and supplies a rinsing volume flow through the suction conduit to the internal combustion engine; and regulating a fuel concentration in the rinsing volume flow by the flow element provided in the aeration conduit.

When the method is performed in accordance with the present invention, it has the advantage that in a simple manner the tank ventilation is improved so that the fuel concentration in the rinsing volume flow is influenced independently from the fuel volume flow and thereby it can be optimized. This is obtained in that, the fuel concentration in the fuel volume flow is regulated by means of the above mentioned flow element provided in the aeration conduit.

It is especially advantageous when the fuel concentration of the rinsing volume flow is calculated first from at least one variable of the motor control, since in this way a sensor for measurement of the fuel concentration of the rinsing volume flow can be dispensed with.

It is also advantageous when the flow element is controlled being open in case of a high flow concentration, since in this manner the negative pressure in the tank ventilating device lowers and the storage thereby discharges the fuel slower to the fresh air. In this manner it is mixing of excessively high fuel quantities in the suction pipe is avoided.

Moreover, it is advantageous when the flow element is controlled being closed in case of a small fuel concentration since in this way the negative pressure in the tank ventilating device is increased, whereby the desorption is regulated and also very low fuel quantities are released from the adsorbing material of the storage. In this way it is achieved that the storage is better regenerated, after the regeneration it has a higher storage capacity, and thereby for example it can be designed smaller than in the prior art.

It is further advantageous when in accordance with the present invention the flow element is formed as a throttable regulating valve, since in this way the fuel concentration in the rinsing volume flow can be regulated.

It is further advantageous when in accordance with the present invention the flow element is formed as a check valve, which is open and closed in cycles, since the check valve in this case is especially inexpensive.

It is further advantageous when in accordance with the present invention the flow valve is controlled electrically, since in this case it has an especially small construction.

Moreover, it is advantageous when the flow element is open without current and thereby a pressure compensation to atmosphere is guaranteed, to avoid that due to fuel vapors a very high positive pressure can be generated in the tank ventilation device.

Moreover, it is advantageous when the pressure in the tank ventilation device is monitored with a pressure sensor, to prevent that by the throttling of the flow element a very high negative pressure is generated in the tank ventilating device and it can be damaging.

The novel features which are considered as characteristic for the present invention are set forth in particular in the appended claims. the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single figure of the drawing is a view illustrating a method of operating a tank ventilation device in accordance with the present invention.

### DESCRIPTION OF THE PREFERRED EMBODIMENTS

The drawing shows a known tank ventilation device in a simplified manner. The tank ventilation device serves for supplying a fuel which is dispersed from a fuel tank, to an internal combustion engine for combustion.

A storage 1 which is formed for example as a cylindrical container is connected through a ventilation conduit 2 with a fuel tank 3, through an aeration conduit 4 with the atmosphere, and through a suction conduit 5 for example with a suction pipe 8 of a internal combustion engine 9. The aeration conduit 4 has for example a flow element 10 and the suction conduit 5 has a tank ventilation valve 11.

The storage 1 temporarily takes the fuel dispersed from the fuel tank 3 in a known manner. The storage 1 contains a material which absorbs a fuel, for example activated carbon. Before the receiving capacity of the storage 1 is exhausted, the tank ventilation valve 11 is opened in a rinsing phase, and fresh air is aspirated due to a negative pressure in the suction pipe 18 via the aeration conduit 4 through the storage 1. The material which absorbs the fuel in the storage 1 releases the received fuel to the fresh air. This process is identified as desorption.

A fuel-air mixture is produced, which is composed of fresh air and the fuel released from the storage. The volume flow of the fuel-air mixture is identified as a rinsing volume flow. The fuel-air mixture is supplied through the tank aeration valve 11 into the suction pipe and is delivered for combustion in the internal combustion engine 9. The tank aeration valve 11 is opened and closed in cycles in a predetermined cycle frequency by a control device 12. In this way the control device 12 controls the fuel volume flow.

After a predetermined rinsing time, the storage 1 releases all fuel and is regenerated. The less fuel remains in the storage 1, the greater subsequently the receiving capacity of the storage 1. The rinsing time must be as short as possible. After finishing the rinsing, the tank aeration valve 11, closes and the storage 1 can again receive the fuel dispersed from the fuel tank 3 for a predetermined loading time, for example during stoppage of the internal combustion engine. The greater the receiving capacity of the storage, the longer the loading time.

The flow element 10 provided in the aeration conduit 4 is for example a throttable regulating valve or a check valve. While the check valve has only the states “open” and “closed”, the throttable regulating valve has many intermediate positions which allow to provide a different rinsing volume flow through the regulating valve. The check valve is for example a magnetic valve which is opened and closed intermittently by the control device 12, so that it produces a desired negative pressure in the storage 1. With the flow element 10 a negative pressure in the storage 1 and in the remaining tank ventilation device is produced, since the fresh air quantity aspirated through the aeration device 4 is limited and more air flows out through the suction conduit 5 into the suction pipe 8 than flows in through the throttled aeration conduit 4 and the ventilation conduit 2.

In the inventive method for ventilation of a tank device, the fuel concentration in the rinsing volume flow is regulated by means of the flow element 10. The fuel concentration is computed as at least one variable of the motor control.

With the known mixture correction of the fuel-air mixture supplied to the internal combustion engine 9 by means of a so-called lambda regulation of the motor control, the fuel mass is known, which is supplied with the rinsing volume flow of the tank aeration into the suction pipe 8. The rinsing volume flow of the tank ventilation is computed for example as a product of an opening time of the tank ventilation valve 11 and the volume stream which is known from a valve characteristic line of the tank ventilation valve 11, with a known pressure difference between the suction pipe 8 and the storage 1. The fuel concentration is provided as the quotient of the fuel mass of the rinsing volume flow and the rinsing volume flow.

With a high fuel concentration in the rinsing volume flow the flow element 10 is controlled more being open. Thereby the negative pressure in the storage 1 lowers so that the desorption or in other words the release of the fuel by the absorbing material in the storage 1 is occurs in a dragging manner. With low fuel concentrations in the rinsing volume flow, the flow element 10 is controlled more in a closing manner. Thereby the negative pressure in the storage 1 increases, so that the desoprtion is advanced. By the increase of the negative pressure at low fuel concentrations in the rinsing volume flow, the storage 1 can be regenerated very well, so that the storage 1 with an equal receiving capacity can be made smaller than in a tank ventilation device which does not operate with this high negative pressure.

The flow element 10 is regulated by means of a regulator of the electronic motor control in a known manner. The electronic control provides a nominal value of the fuel concentration in the rinsing volume flow, depending on the respective operational state.

During idle running for example a very little fuel is required for the internal combustion engine, so that the fuel concentration and the rinsing volume flow is regulated to a lower level.

In a thrust operation the tank ventilation valve 11 is closed and the regulation of the fuel concentration in the rinsing volume flow is discontinued, since the internal combustion engine requires no fuel. If the fuel is mixed through the tank ventilation in the suction pipe 8, the fuel in the internal combustion engine is not burnt or is not completely burnt, so that the hydrocarbon emissions are increased.

The flow element 10 is opened in a currentless fashion, to guarantee that with the turned-off internal combustion engine 9, a pressure compensation with respect to environment and thereby a positive pressure in the fuel tank 3, for example by heating of the fuel, is avoided, or an unobjectionable refueling of the fuel tank 3 is possible.

The pressure in the tank ventilation device can be measured with a pressure sensor 15 and monitored. The pressure sensor 15 is provided for example on the fuel tank 3. The pressure sensor 15 can be also provided on the storage 1 as well. When the pressure in the tank ventilation device exceeds a predetermined pressure by the throttling of the flow element 10, then with the measuring signal of the pressure sensor 16 through the regulator, the flow element 10 is controlled being open, so that the pressure in the tank ventilation device is further increased. In this manner, damages to the tank ventilation device by an excessive negative pressure are prevented.

It will be understood that each of the elements described above, or two or more together, may also find a useful application in other types of constructions differing from the types described above.

While the invention has been illustrated and described as embodied in method of operating a tank ventilation device, it is not intended to be limited to the details shown, since various modifications and structural changes may be made without departing in any way from the spirit of the present invention.

without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A method of operating a tank ventilation device including a fuel tank of an internal combustion engine and a storage which receives a fuel dispersed from the fuel tank, comprising the steps of connecting the storage through a ventilation conduit with the fuel tank, through a suction conduit with the internal combustion engine, and through an aeration conduit provided with a flow element with an atmosphere; supplying through the storage in a rinsing phase a fresh air which is aspirated via the aerating device, takes fuel and supplies a rinsing volume flow through the suction conduit to the internal combustion engine; and regulating a fuel concentration in the rinsing volume flow by the flow element provided in the aeration conduit.

2. A method as defined in claim 1; and further comprising computing the fuel concentration of the rinsing volume flow from at least one variable of a motor control.

3. A method as defined in claim 1; and further comprising controlling the flow element at high fuel concentrations of the fuel volume flow in a more open fashion.

4. A method as defined in claim 1; and further comprising controlling the flow element at low fuel concentrations of the rinsing volume flow in a more closed fashion.

5. A method as defined in claim 1; and further comprising forming the flow element as a throttable regulating valve.

6. A method as defined in claim 1; and further comprising forming the flow element as a check valve which is controlled in a cycled manner.

7. A method as defined in claim 1; and further comprising electrically controlling the flow element.

8. A method as defined in claim 1; and further comprising opening the flow element in a currentless manner.

9. A method as defined in claim 1; and further comprising monitoring a pressure in the tank ventilation device by a pressure sensor.

10. A method as defined in claim 1; and further comprising closing a tank ventilation valve during a trust operation.
